(19) United States
(12) Patent Application Publication
(10) Pub. No.: US 2024/0309596 A1
(43) Pub. Date: Sep. 19, 2024

(54) Cost-effective bike lane sweeper

(71) Applicant: Pierre Lermant, Sunnyvale, CA (US)

(72) Inventor: Pierre Lermant, Sunnyvale, CA (US)

(21) Appl. No.: 18/123,312

(22) Filed: Mar. 19, 2023

(51) Int. Cl. E01H 1/05; B62J 43/10; B62J 43/30; E01H 1/04

(52) U.S. Cl. CPC E01H 1/056; B62J 43/10; B62J 43/30; E01H 1/047

(57) ABSTRACT

The embodiments include a primary frame (10) supported by two wheels (50), and connected to a towing vehicle via a tow bar (18). A cylindrical brush assembly (1) is mounted on a secondary frame (12), which rotates around the primary frame. The brush rotation is driven by an electric motor (110, 220) attached to the secondary frame. The brush rotation goes counter to the wheels' rotation. The amount of pressure between the brush and the ground is controlled by the length of a spring (23) that links the two frames. In one embodiment, the brush axis forms an angle (280) with the wheels' rotation axis, and the debris gets pushed to the side as the sweeper moves forward. In another embodiment, the brush axis is parallel to the wheels' rotation axis and the debris is driven around the brush by a wrap-around guide (100), into a hopper (140).

### BACKGROUND—PRIOR ART

The following is a tabulation of some prior art that presently appears relevant:

### U.S. Patent Documents

| | Kind | | |
|---|---|---|---|
| Pat. No. | Code | Issue Date | Patentee |
| 3,947,912 | A | Apr. 6, 1976 | Abraham Michaels |
| 20190145071 | A1 | May 16, 2019 | Rodney M. Kramer |
| 7,716,773 | B1 | May 18, 2010 | Gaylord M. Pahl, et al. |
| 7,644,779 | B1 | Jan. 12, 2010 | David J. Templeton, et al. |
| 5,742,968 | A | Apr. 28, 1998 | David Nicholson |
| 10/137,815 | B2 | Nov. 27, 2018 | Arthur Zanini |
| 3,212,118 | A | Oct. 19, 1965 | Charles C Anderson |
| 3,649,982 | A | Mar. 21, 1972 | Donald G Mortensen |

### Foreign Patent Documents

| Country | | Kind | | |
|---|---|---|---|---|
| Code | Pat. No. | Code | Issue Date | Patentee |
| KR | 10/1,675,423 | B1 | Nov. 11, 2016 | [symbol] , et al |
| AU | 2005238091 | B2 | Nov. 12, 2009 | Eddie Fitzgerald |

Street shoulders and traditional bike lanes that share the pavement with motor vehicles accumulate debris over time, as regular car and truck traffic pushes debris to the edge of the road. As a result, bicycle riders experience bumpy, slippery and prone-to-puncture rides. To avoid these poor conditions, riders tend to merge into the main traffic lanes where the pavement is generally cleaner, creating hazardous situations.

In urban areas, full-sized street cleaners can sweep traditional bike lanes, however for economic reasons they will often only clean the swaths of pavement trafficked by motor vehicles, making the sides of the pavement, where bicycles operate, even dirtier.

Protected bike lanes and bike paths that are separated from motor vehicle pavement can also become unpleasant or hazardous to ride due to objects brought in by other factors, such as leaves, rocks, twigs, mud, or litter and trash left behind.

Because of physical width constraints and environmental reasons, protected bike lanes and bike paths cannot be cleaned by full-sized street sweepers.

Finally, roadsides in-between cities are rarely swept due mostly to economic reasons. In addition, a slow-moving full-sized sweeper may become hazardous to car and truck traffic operating on the same roads at much higher speeds.

To remedy the situations highlighted above, smaller versions of the full-sized street sweepers have been commercialized. They operate like the larger devices yet their reduced width allows them to clean narrow swaths of pavement, like protected bike lanes or bike paths. However, their expensive price tag, cost of operation, maintenance and storage all severely limit their adoption and use.

Some motorized and human-powered walk-behind narrow sweepers have also been commercialized, but their very limited range makes them only suitable for specific environments like airports.

With the near-universal expansion of bike lanes and bike paths to curb car traffic, there is a need for an ecological and cost-effective bike lane sweeper that can clean all surfaces where bicycles travel.

### SPECIFICATIONS; DETAILED DESCRIPTION

The drawings described herein are for illustrative purposes only and illustrate only selected embodiments. The enclosed drawings are not intended to limit the scope of the present disclosure. In the brief and detailed description sections, an angled brush refers to a brush whose main axis of rotation is not orthogonal to the sweeper direction of motion, and a straight brush refers to a brush whose main axis of rotation is approximately orthogonal to the sweeper direction of motion.

### BRIEF DESCRIPTION OF THE DRAWINGS

### Straight-Brush Embodiment:

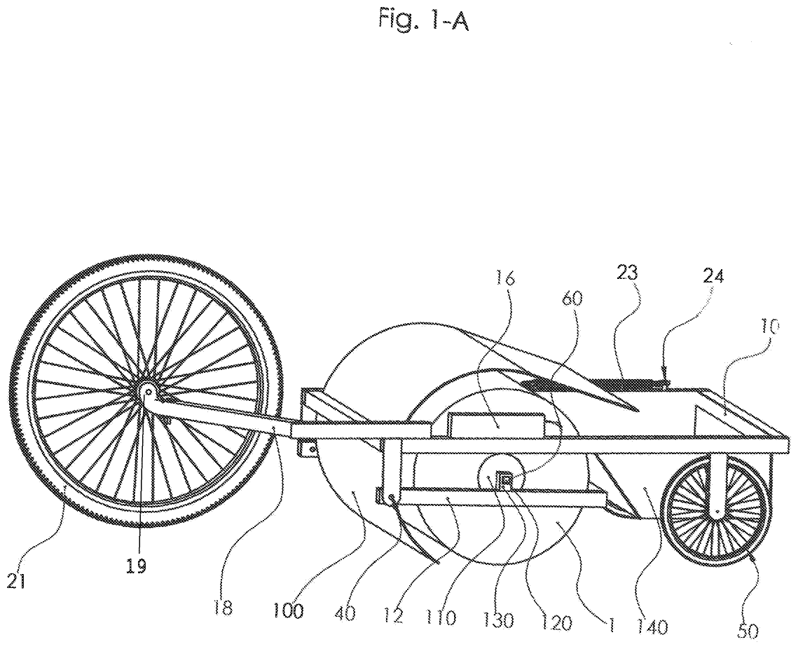

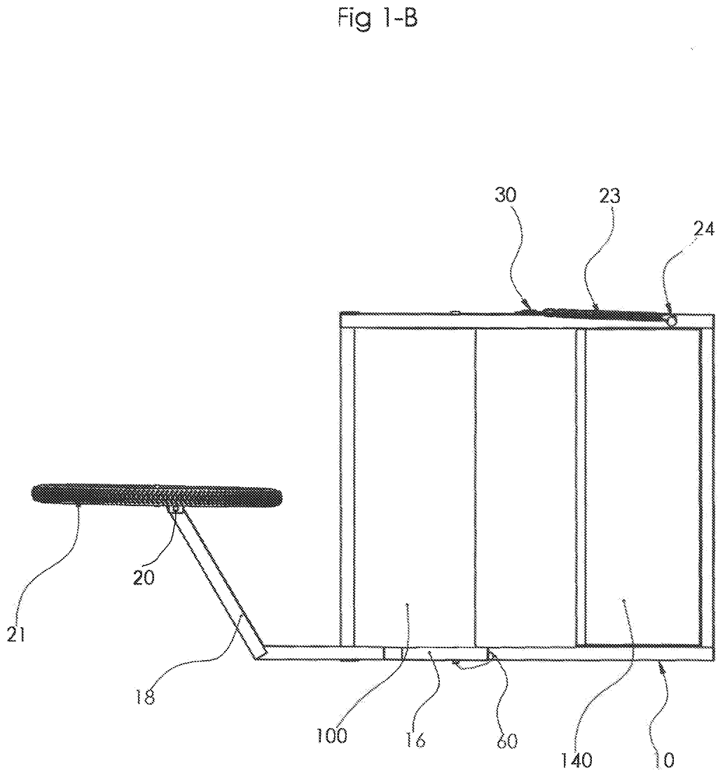

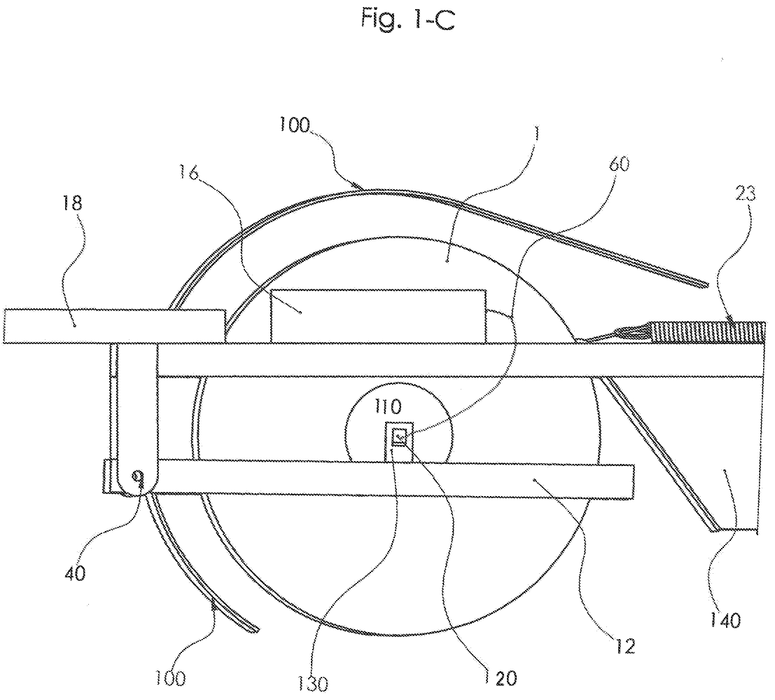

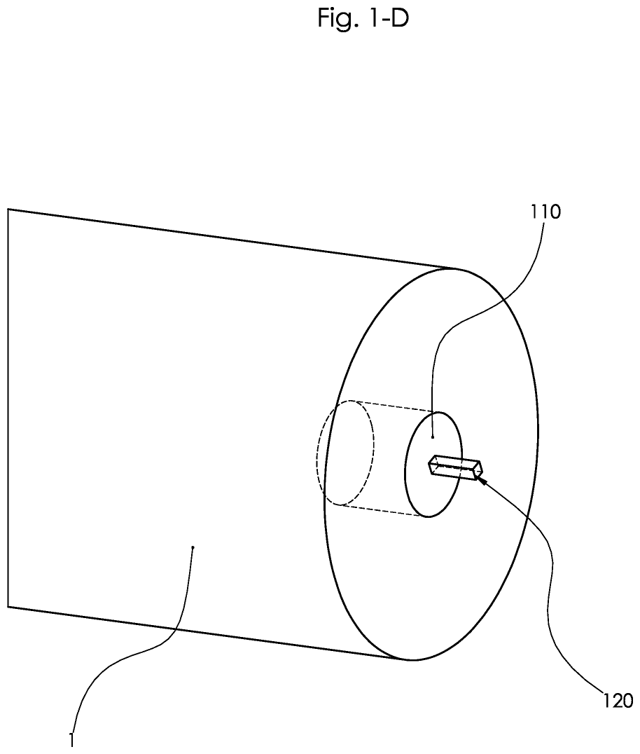

FIG. 1-A: Isometric view of the apparatus. It tags and identifies the main parts of the invention visible in this view.

FIG. 1-B: Top view of the apparatus. It tags and identifies the main parts of the invention visible in this view.

FIG. 1-C: Left detailed view of the apparatus. It tags and identifies the main parts of the invention visible in this view.

FIG. 1-D: Isometric detailed view of the electric hub motor, its square drive and the brush. It tags and identifies the main parts of the invention visible in this view.

### Angled-Brush Embodiment;

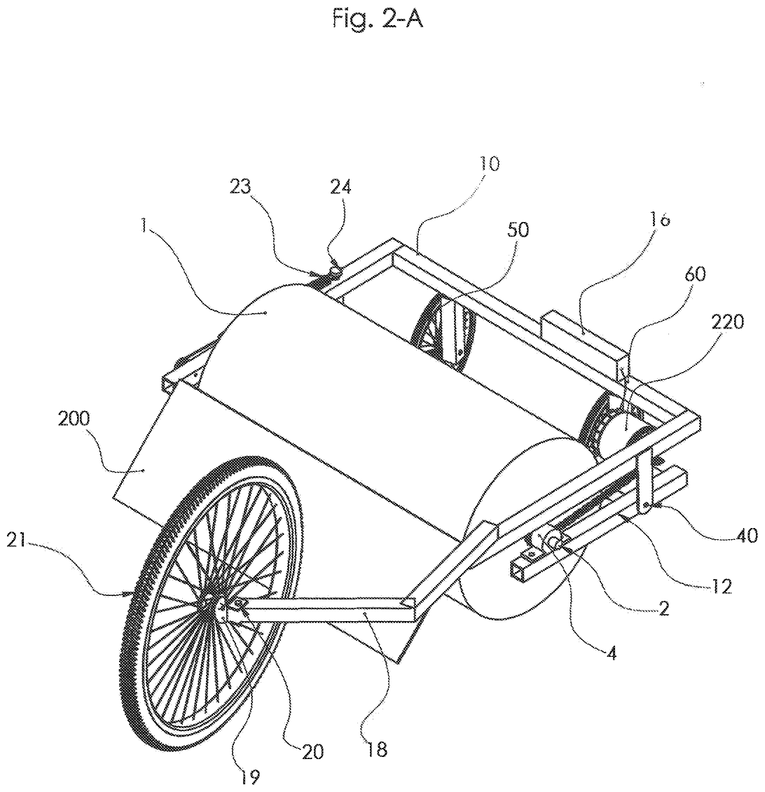

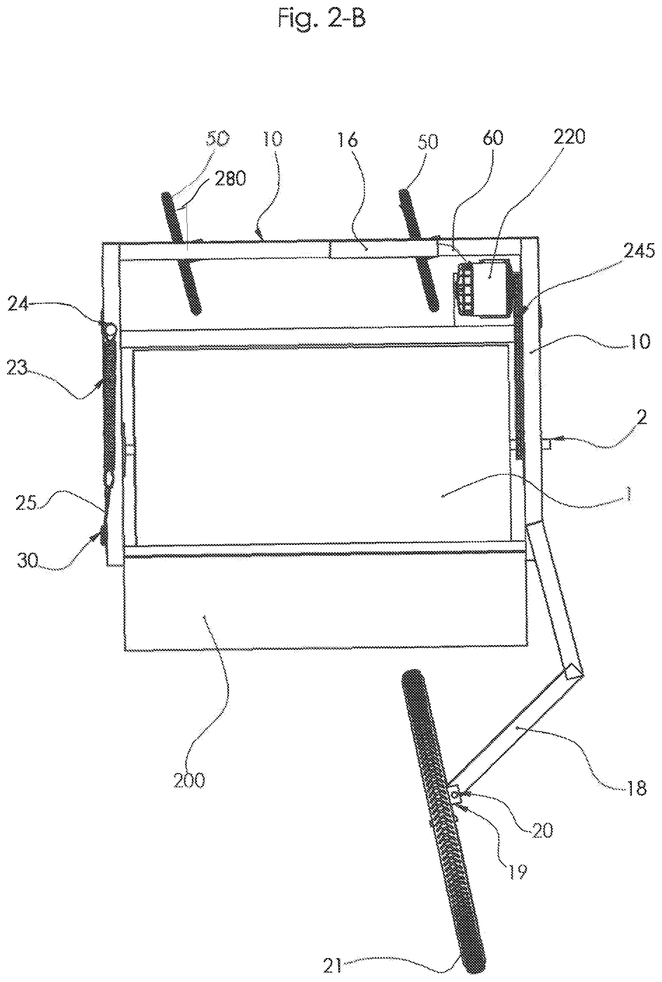

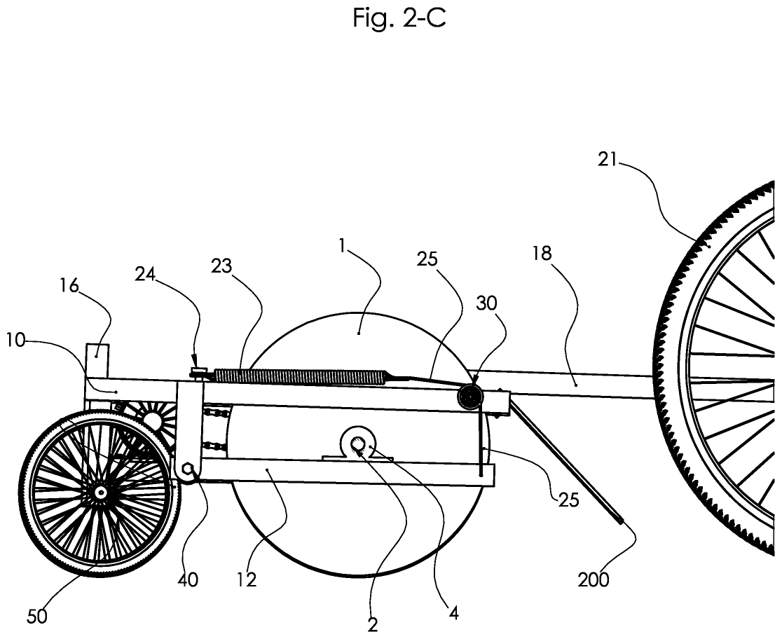

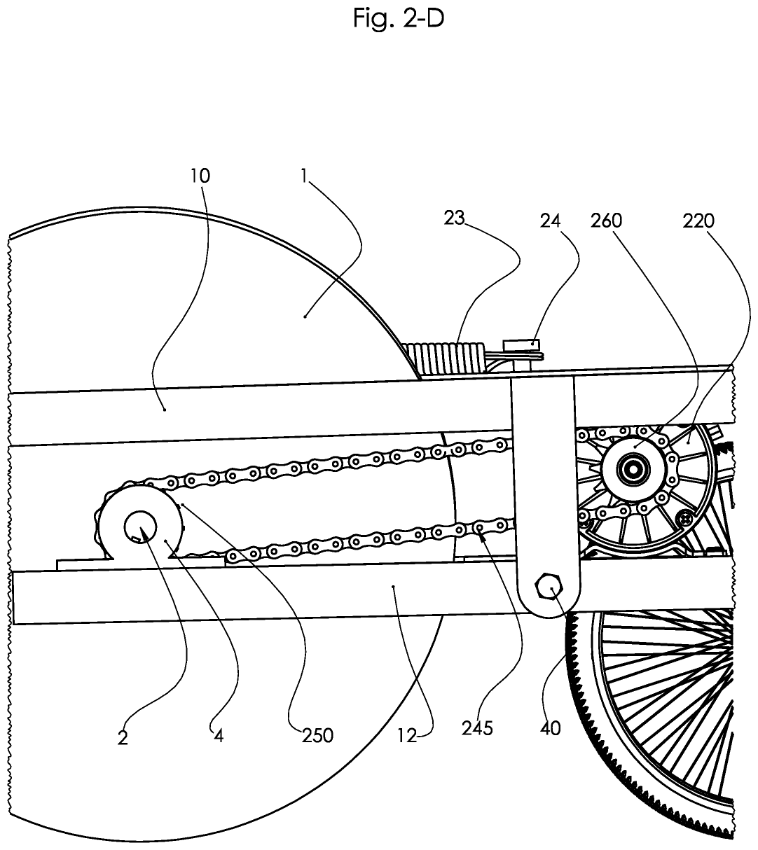

FIG. 2-A: Isometric view of the apparatus. It tags and identifies the main parts of the invention visible in this view.

FIG. 2-B: Top view of the apparatus. It tags and identifies the main parts of the invention visible in this view

FIG. 2-C: Right view of the apparatus. It tags and identifies the main parts of the invention visible in this view

FIG. 2-D: Left detailed view of apparatus. It tags and identifies the main parts of the invention visible in this view

### DETAILED DESCRIPTION OF THE DRAWINGS, FIRST EMBODIMENT

An embodiment of the sweeper with a straight brush and a hopper, towed by a bicycle, is illustrated in FIGS. 1-A through 1-D. A primary frame 10, forming an approximate rectangle, and made of rigid material, for instance, aluminum, fiberglass or steel, serves as the main structure of the sweeper. A cylindrical brush 1 made of a core and sweeping bristles is attached to a secondary frame 12, which can rotate around frame 10 via pivot points 40.

The frame 10 is supported by two wheels 50 positioned behind the brush 1. Their axis of rotation is approximately orthogonal to the sweeper direction of motion. The distance between the outside surfaces of two wheels 50 is slightly smaller than the width of the brush 1.

This particular wheel positioning provides the following advantages, while allowing a hopper 140 to fit between the wheels 50:
It avoids slippage between the wheels 50 and the ground as the sweeper moves forward, as they spin freely.
The wheels 50 roll on a surface that is cleaned by the brush 1 ahead of them, minimizing rolling resistance.
When the surface to be cleaned is bordered by a natural shoulder or a gutter on its right-hand side, the brush 1 can sweep the full pavement width while keeping the wheels 50 on the main pavement.

A bicycle rear wheel 21 axle hitch 19 is attached to the front of a tow bar 18 and secured by a pin 20. The rear end of the tow bar 18 is affixed to the front of the main frame 10.

On one side of the brush 1, a single-shaft hub motor 110 fits tightly inside the core of the brush 1, which is hollow. The motor shaft 120 is affixed to one side of the frame 12 by a connector 130. The electrical wires 60 coming out of the shaft are connected to a battery 16 secured to the frame 10. The other side of the brush 1 is fitted with a short shaft 2, which rests inside a pillow bearing 4, attached to the side of the secondary frame 12.

A debris guide 100 wraps around the brush 1, leaving a small gap between the extremity of the brush bristles and the guide 100 (FIG. 1-A). Debris swept by the rotating brush 1 gets trapped between the brush 1 and the guide 100, and eventually gets dumped into the hopper 140 resting on the back of the frame 10.

One end of an extension spring 23 is attached to an anchor 24 tied to one side of the frame 10, and the other end of the spring 23 is attached to one end of a cable 25. The cable 25 bends around a pulley affixed to the frame 10 and the cable 25 other end is attached to the secondary frame 12 (FIG. 2.C). The positioning of the anchor 24 along the frame 10 controls precisely the amount of pressure between the brush 1 and the ground. The limited friction between the brush 1 bristles and the ground offers little towing resistance while providing effective sweeping. Given the expected usage of the sweeper, a brush 1 width between 60 cm and 1.2 m (about two to four feet) will be appropriate for most cleaning jobs, although wider or more narrow brushes can be considered.

Operation. FIGS. 1-A Through 1-D.

On an approximately flat surface, with the bicycle at rest and standing, for instance on a kickstand, the bicycle operator first attaches the front end of the tow bar 18 to the bicycle rear wheel 21 axle hitch 19, secured by a pin 20. The operator then sets the position of the anchor 24 on the main frame 10 to achieve a proper pressure between the brush 1 and the ground. The battery 16 is connected to the motor 110 by a wire 60, which drives the rotation of the brush 1 counter to the direction of motion.

The operator rides the bicycle over the surface to be cleaned, typically at a low speed, towing the sweeper. As the spinning brush 1 moves forward, debris gets picked up and is forced between the brush 1 and the guide 100, and eventually lands in the hopper 140.

When the cleaning job is over or when the hopper 140 is full, the operator dismounts the bicycle, disconnects the battery 16 from the motor 110 and empties out the hopper 140.

### DETAILED DESCRIPTION OF THE DRAWINGS, SECOND EMBODIMENT

An alternative embodiment of the sweeper with an angled brush 1, towed by a bicycle, is illustrated in FIGS. 2-A to 2-D. A frame 10 forming an approximate rectangle and made of rigid material, for instance aluminum, fiberglass or steel, serves as the main structure of the sweeper. A cylindrical brush 1, made of a core and sweeping bristles is attached to a secondary frame 12, which can rotate around frame 10 via pivot points 40.

The frame 10 is supported by two wheels 50 positioned behind the brush 1. Their axis of rotation is approximately parallel to the towing wheel 21 axis of rotation, and forms a low angle 280, typically 15 to 20 degrees, with the brush 1 axis of rotation (FIG. 2-B). This allows the debris to be pushed forward and to the side as the sweeper moves forward. Other angles can be considered: A lower angle 280 will maximize the effective sweeping width. A higher angle 280 will allow for larger volumes of debris to be pushed to the side of the sweeper at a given speed. The effective sweeping width is measured by projecting the width of the angled brush 1 onto a line orthogonal to the direction of motion. For instance, with an angle 280 set to 15 degrees, the effective width is about 0.966 times the width of the brush 1.

The distance between the outside surfaces of two wheels 50 is smaller than the width of the brush 1., which provides the following advantages:
It avoids slippage between the wheels 50 and the ground as the sweeper moves forward.
The wheels 50 roll on a surface that is cleaned by the brush 1 ahead of them, minimizing rolling resistance.
When the surface to be cleaned is bordered by a natural shoulder or a gutter on its right-hand side, the brush 1 can sweep the full pavement width while keeping the wheels 50 on the main pavement.

A bicycle rear wheel 21 axle hitch 19 is attached to the front of a tow bar 18 and secured by a pin 20. The rear end of the tow bar 18 is affixed to the front of the main frame 10. The bicycle rear wheel 21 is parallel to the wheels 50 supporting the frame. Consequently, the bicycle rear wheel axis also forms an angle 280 with the brush 1 axis.

One side of the brush 1 is fitted with a short shaft 2, which rests inside a pillow bearing 4, attached to one side of the secondary frame 12. The other side of the brush 1 is fitted with a second shaft 2, which rests inside a pillow bearing 4, attached to the other side of the secondary frame 12. This second shaft 2 is fitted with a sprocket 250 (FIG. 2-D).

An electric motor 220, affixed to the secondary frame 12 is coupled via a sprocket 260 with the brush shaft sprocket 250 by a chain 245. This sprocket and chain mechanism transfers the electric motor 220 rotational energy to the brush 1. The brush 1 rotation is opposite to the bicycle rear wheel 21 rotation. The desired brush 1 rotation speed mostly depends on the surface to be cleaned, the angle 280, the outside diameter of the brush 1, the size and material of the brush 1 bristles, and the expected sweeper forward speed. Higher rotation speeds tend to provide better cleaning effectiveness; however, they result in higher power consumption and more pull resistance. The brush 1 rotation speed is controlled by the motor 220 RPM (rounds per minute) and the sprockets 250 and 260 size ratio. Other couplings between the motor 220 and the brush shaft 2 can be considered, like a belt and pulleys, or direct coupling.

An angled splash guard 200, made of abrasion-resistant material, extends the front of the frame 10 down to prevent debris from being ejected too high and become a hazard (FIG. 2-A 2-B).

A battery 16, secured to the frame 10, supplies the power to the electric motor 220 via electrical wires 60. Given the expected usage of the sweeper, a brush 1 width between 60 cm and 1.2 m (about two to four feet) will be appropriate for most cleaning jobs, although wider or more narrow brushes can be considered.

One end of an extension spring 23 is attached to an anchor 24 tied to one side of the frame 10, and the other end of the spring 23 is attached to one end of a cable 25. The cable 25 bends around a pulley affixed to the frame 10 and the cable 25 other end is attached to the secondary frame 12 (FIG. 2.C). The positioning of the anchor 24 along the frame 10 sets precisely the amount of pressure between the brush 1 and the ground. The limited friction between the brush 1 bristles and the ground offers little towing resistance while providing effective sweeping.

Operation. FIGS. 2-A Through 2-D.

On an approximately flat surface, with the bicycle at rest and standing, for instance on a kickstand, the bicycle operator first attaches the front end of the tow bar 18 to the bicycle rear wheel 21 axle hitch 19, secured by a pin 20. The operator then sets the position of the anchor 24 on the main frame 10 to achieve a proper pressure between the brush 1 and the ground. The battery 16 is connected to the motor 220, which drives the spinning of the brush 1 counter to the direction of motion.

The operator rides the bicycle over the surface to be cleaned. As the spinning angled brush 1 moves forward, debris gets picked up and ejected forward and to the right-hand side of the sweeper. If an area larger than the effective width of the brush 1 needs to be cleaned, the operator will clean it over multiple passes, going from the left to the right of the surface. When the cleaning job is over, the operator dismounts the bicycle and disconnects the battery 16 from the motor 220.

Since the overall weight of both embodiments is modest and the friction between the brush 1 and the surface to be cleaned is minimized, a reasonably fit operator can sweep multiple kilometers (miles) of bike lanes in a single session with a conventional bicycle. For longer jobs, large brush 1 widths or for uphill terrain the sweeper can be towed by an electric bicycle or any other powered vehicle.

The relatively small size and weight of the sweeper make it easy to store in one location and transport to and from areas to be cleaned.

### CONCLUSION, RAMIFICATIONS, AND SCOPE

Accordingly, the reader will see that the tow-behind sweeper of the various embodiments exhibits the following advantages:
Its simple design, few and inexpensive parts make it a cost-effective sweeper to make, store, operate and maintain.
Its modest weight and pull resistance allow very low-power vehicles to tow the sweeper over significant distances, making it ecologically friendly.
Its tow bar can be easily attached to a variety of towing vehicles, including conventional and electric bicycles.
Its suspension system allows for fine-tuning of the pressure between the brush and the ground, allowing for effective sweeping while minimizing the pull resistance and brush wear.
Its modest dimensions and weight make it easy to transport, and it can fit any bikeways and bike paths where bicycles are allowed to travel.

The angled brush embodiments will be preferred when the bike lane or path is bordered by a gutter or natural shoulder and the swept debris does not have to be picked up by the sweeper.

The straight brush embodiments with a hopper will be preferred for protected bike lanes bordered by physical separators, or when the debris cannot be left on the side of the device and needs to be picked up by the sweeper.

Additionally, the sweeper can operate on other surface areas, like sidewalks, golf courses, or industrial floors.

While the above-detailed descriptions contain many specifics, there should not be construed as limitations of the scope, but rather as an exemplification on two embodiments thereof. Many other variations are possible, for example:

The first or the second embodiment of the sweeper, where the electric motor shaft is directly coupled with the brush shaft.

The first or the second embodiment of the sweeper, where the amount of pressure between the brush and the ground is controlled by a gas or hydraulic piston.

The first embodiment of the sweeper can have the single-shaft hub motor inside the brush core replaced by the electric motor affixed to the frame described in the second embodiment.

The second embodiment of the sweeper can have the electric motor affixed to the frame replaced by the single-shaft hub motor inside the brush core described in the first embodiment.

The second embodiment of the sweeper, where the debris gets swept to the left instead of to the right of the sweeper as it moves forward

I claim:

1. A tow-behind sweeper comprising:
a. A primary frame supported by a plurality of wheels, said wheels' axis of rotation forms an approximate right angle with said sweeper direction of motion,
b. A tow bar having its front-end attached to a tow vehicle and its back-end connected to said primary frame,
c. A secondary frame, whereby said secondary frame pivotally moves about the said primary frame,
d. A cylindrical brush assembly mounted to said secondary frame, wherein the distance between said brush assembly and the ground is in direct relationship with the angle between said primary frame and said secondary frame,
e. Means for controlling the amount of pressure between said brush assembly and the ground,
f. A rotational-energy generating electric motor,
g. Means for transferring said electric motor rotational-energy to said brush assembly, whereby the rotation direction of said brush assembly is opposite to the rotation direction of said wheels.

2. The sweeper of claim 1 wherein means for transferring said electric motor rotational-energy to said brush assembly is achieved by a chain and sprockets.

3. The sweeper of claim 1 wherein means for transferring said electric motor rotational-energy to said brush assembly is achieved by a belt and pulleys.

4. The sweeper of claim 1 wherein means for transferring said electric motor rotational-energy to said brush assembly is achieved by direct coupling.

5. The sweeper of claim 1 wherein said brush assembly extends on one end with a generally horizontal axle mounted on one side of said secondary frame, said brush assembly has a hollow core with a cylindrical opening on the other end, said electric motor is a cylindrical single-shaft hub motor encased in opening of said brush assembly, said single-shaft is attached to one side of said secondary frame, wherein the means for transferring said electric motor rotational-energy to said brush assembly is achieved by direct coupling or friction between the outer surface of said hub motor and said brush assembly inner core surface.

6. The sweeper of claim 1 wherein the axis of rotation of said brush assembly forms an approximate right-angle with said sweeper direction of motion, wherein the axis of rotation between said primary frame and said secondary frame is parallel to the axis of rotation of said brush assembly.

7. The sweeper of claim 6 further comprising a hopper behind said brush assembly supported by said primary frame, a guide wrapping around said brush assembly, whereby debris picked up by said brush assembly as it moves forward is channeled into said hopper.

8. The sweeper of claim 1 wherein the axis of rotation of said brush assembly does not form a right-angle with said sweeper direction of motion, wherein said wheels' axis of rotation forms an angle with said brush assembly's axis of rotation.

9. The sweeper of claim 8 wherein the axis of rotation between said primary frame and said secondary frame is parallel to the axis of rotation of said brush assembly.

10. The sweeper of claim 8 wherein the axis of rotation between said primary frame and said secondary frame forms an angle with the axis of rotation of said brush assembly.

11. The sweeper of claim 8 further comprising a debris splash guard attached to the front of said primary frame, running approximately the width of said primary frame to keep debris close to the ground as it is swept forward and to the side by said brush assembly.

12. The sweeper of claim 1 wherein means for controlling the amount of pressure between said brush assembly and the ground is achieved with a spring linking said primary frame with said secondary frame, whereby the length of said spring determines the amount of pressure between said brush assembly and the ground.

13. The sweeper of claim 1 wherein means for controlling the amount of pressure between said brush assembly and the ground is achieved with a piston linking said primary frame with said secondary frame, whereby the length of said piston determines the amount of pressure between said brush assembly and the ground.

14. The sweeper of claim 1 wherein said tow vehicle is a bicycle.

15. The sweeper of claim 1 wherein said tow vehicle is powered by a battery, said battery also powers said electric motor.
